(19) United States
(12) Patent Application Publication
(10) Pub. No.: US 2006/0007690 A1
(43) Pub. Date: Jan. 12, 2006

(54) LED lamp

(76) Inventor: Tsian-Lin Cheng, Yung-Kang City (TW)

Correspondence Address: Tsan-Ling Cheng, P.O. Box 90, Tainan City, 704, TW

(21) Appl. No.: 10/884,996

(22) Filed: Jul. 7, 2004

(51) Int. Cl. F21V 19/00

(52) U.S. Cl. 362/382

(57) ABSTRACT

An LED lamp includes a lamp base, a transparent shell on the lamp base, a lamp unit consisting of an electric circuit board and a plurality of LED, and a transparent cap. The transparent shell is provided with an annular resting edge in an inner annular wall for the lamp unit to position thereon. The lamp unit is connected electrically with the lamp base, and the transparent cap is positioned on the transparent shell. Then the light of the LED lamp shines forward and sidewise through the transparent shell and the transparent cap to a comparatively large range.

### BACKGROUND OF THE INVENTION

1. Field of the Invention

This invention relates to an LED lamp, particularly to one provided with lamp base, a transparent shell formed on the lamp base and having an annular resting edge in an inner annular wall for securing a lamp unit thereon. The lamp unit consists of an electric circuit board and a plurality of LED (light emitting diodes), connected electrically with the lamp base. Further, a transparent cap is provided to cover on the transparent shell so that the light of the LED may shine sidewise and forward through the transparent shell and the transparent cap, reaching a comparatively wide range.

2. Description of the Prior Art

Common conventional lamps 1 for vehicles shown in FIG. 1 generally have a lamp base 10 and a lamp 11 positioned on the lamp base 10, and the lamp 11 is made of tungsten filaments, which is apt to get extremely hot and to break during running of a vehicle, in addition to its brilliant shining to irritate eyes.

### SUMMARY OF THE INVENTION

This invention has been devised to offer an LED lamp provided with a light unit positioned on an annular resting edge of a transparent shell on a lamp base, and a transparent cap positioned on the transparent shell and covering over the light unit, letting the light of the LED lamp of the light unit shine forward and sidewise through the transparent cap and the transparent shell.

The feature of the invention is a lamp base, a transparent shell formed on the lamp base and having an annular resting edge in the annular wall and an annular step near the upper end above the resting edge, and a lamp unit arranged in the transparent shell on the lamp base and consisting of an electric circuit board and a plurality of LED. The lamp unit is electrically connected with the lamp base, and the electric circuit board is positioned on the annular resting edge of the transparent shell, with a transparent cap provided with a flange fitting with the annular step of the transparent shell for covering over the LED lamp.

### BRIEF DESCRIPTION OF DRAWINGS

This invention will be better understood by referring to the accompanying drawings, wherein:

FIG. 1 is a perspective view of a conventional lamp;

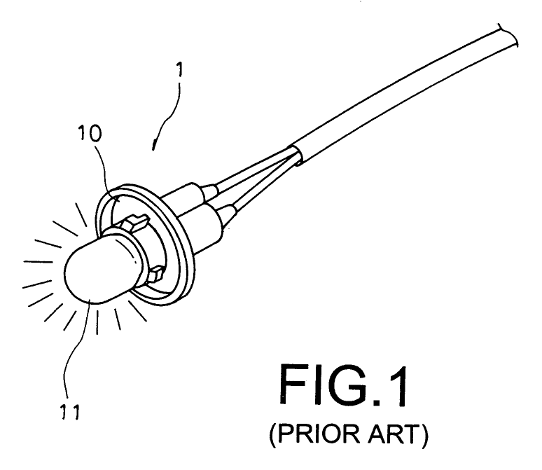

FIG. 2 is an exploded perspective view of an LED lamp in the present invention;

FIG. 3 is a perspective view of the LED lamp in the present invention;

FIG. 4 is a side cross-sectional view of the LED lamp in the present invention; and,

FIG. 5 is a perspective view of the LED lamp positioned on a reflective plate for use in the present invention.

### DETAILED DESCRIPTION OF THE PREFERRED EMBODIMENT

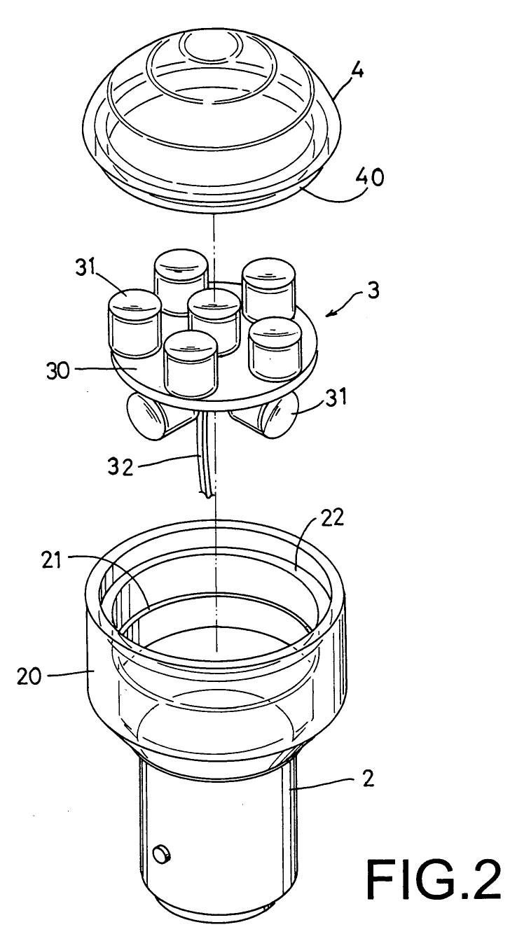

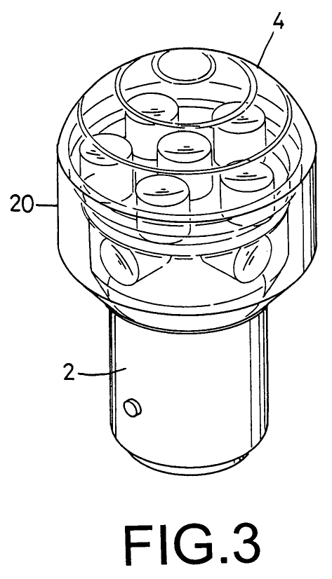

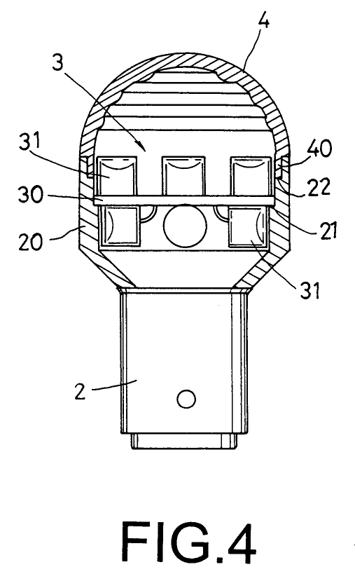

A preferred embodiment of an LED lamp in the present invention, as shown in FIGS. 2, 3 and 4, includes a lamp base 2, a transparent shell 20, a lamp unit 3, and a transparent cap 4 as main components.

The transparent shell 20 is formed on the lamp base 2 of a preferably cylindrical shape, having an annular resting edge 21 formed in an inner annular wall and an annular step 22 formed above the resting edge near an upper end.

The lamp unit 3 consists of an electric circuit board 30 and a plurality of LED 31, and electric wires 32 connecting the lamp unit 3 with the lamp base 2. The electric circuit board 30 is positioned securely on the annular resting edge 21, and LED 31 are arranged on an upper surface of the electric circuit board and can also be positioned under the electric circuit board 30. The lamp unit 3 is arranged to position in the transparent shell 20.

The transparent cap 4 is positioned to cover over the lamp unit 3 and on the transparent shell 20, having a flange 40 in a lower end to position on the annular step 22 of the transparent shell 20 so as to let the transparent cap 4 secured in position.

In assembling, as shown in FIGS. 2, 3 and 4, the electric circuit board 30 of the lamp unit 3 is placed securely on the annular resting edge 21 of the transparent shell 20 at first, and then the annular step 22 is coated with waterproof glue. Subsequently, the transparent cap 4 is placed in the transparent shell 2 with the flange 40 seated and bonded on the annular step 22, finishing the assembly of the LED lamp in the invention.

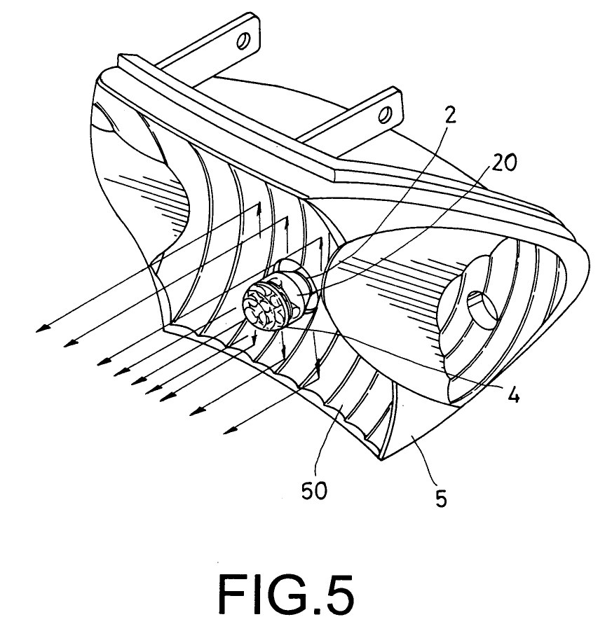

The finished LED lamp can be applied to a reflective plate 5 provided with many reflective surfaces 50, as shown in FIG. 5. Then the light of the LED 31 can shine through the transparent shell 20 and the transparent cap 4 sidewise and forward, and then is reflected to shoot out with different angles in every direction by the reflective surfaces 50 of the reflective plate 5. Therefore, the bright light of the LED can be cast into a very large area, upgrading the efficiency of illumination.

While the preferred embodiment of the invention has been described above, it will be recognized and understood that various modifications may be made therein and the appended claims are intended to over all such modifications that may fall within the spirit and scope of the invention.

What is claimed is:

1. An LED lamp comprising:
a lamp base and a transparent shell of a preferably cylindrical shape, said transparent shell positioned on said lamp case and provided with an annular resting edge formed in its inner annular wall and an annular step formed above said annular resting edge near the upper end;
a lamp unit arranged to position in said transparent shell and consisting of an electric circuit board and a plurality of LED and electric wires connecting said lamp unit with said lamp base, said electric circuit board positioned on said annular resting edge of said transparent shell, said LED positioned on and under said electric circuit board;
a transparent cap provided to cover over said lamp unit and having a flange in a lower end to correspond to said annular step of said transparent shell; and,
said lamp unit positioned on said annular resting edge of said transparent shell, the upper end of said transparent shell coated with waterproof glue to bond with the lower end of said transparent cap placed on said transparent shell, the light of said LED lamps shining through said transparent shell and said transparent cap sidewise and forward to a comparatively large range.
